(19) United States
(12) Patent Application Publication
(10) Pub. No.: US 2012/0320988 A1
(43) Pub. Date: Dec. 20, 2012

(54) VIDEO SENDING APPARATUS, VIDEO RECEIVING APPARATUS, AND VIDEO SENDING METHOD

(76) Inventors: Koji KAMIYA, Kanagawa (JP); Yukio Yamazaki, Kanagawa (JP)

(21) Appl. No.: 13/492,546

(22) Filed: Jun. 8, 2012

(30) Foreign Application Priority Data
Jun. 16, 2011 (JP) 2011-133958

(51) Int. Cl. H04N 7/30

(52) U.S. Cl. 375/240.18; 375/E07.226

(57) ABSTRACT

Provided is a video sending apparatus, comprising: a compression unit configured to handle, in encoded video data encoded by pixel unit, a predetermined number of continuous pieces of pixel data as a differential-data-generating unit, the predetermined number being two or more, to cause the first piece of pixel data in the differential-data-generating unit to pass through, and to transform the pieces of pixel data other than the first piece of pixel data into pieces of differential data to thereby generate compressed video data, each of the pieces of differential data indicating a change amount from the preceding piece of pixel data in one of a positive direction and a negative direction; and a sending unit configured to send the compressed video data generated by the compression unit.

### BACKGROUND

The present disclosure relates to a video sending apparatus, a video receiving apparatus, and a video sending method of video data transmission.

In a broadcast station, a plurality of cameras are connected to a camera control unit (CCU) via cables. Video signals and sound signals captured by the cameras are sent to the CCU via the cables as analog composite signals (VBS) and component signals. In many cases, coaxial cables and the like are used as the cables.

However, the system, in which video signals and sound signals are transmitted as analog signals, has a tendency that the signal waveform and the image quality are degraded with the increase of the transmission distance. In view of this, for example, Japanese Patent Application Laid-open No. H10-341357 (hereinafter, referred to as Patent Document 1) discloses a technique in which a signal to be transmitted is transformed into a digital signal.

However, even if a signal to be transmitted is digitalized, there is a fear in that noise resistance is degraded with the increase of the frequency of the signal to be transmitted, and that the signal may not be transmitted. This is because attenuation of the signal level is increased with the increase of transmission distance.

### SUMMARY

In view of the above-mentioned circumstances, it is desirable to provide a video sending apparatus, a video receiving apparatus, and a video sending method capable of reducing the transmission bit amount and increasing the video transmission stability.

According to the first aspect of the present disclosure, there is provided a video sending apparatus, comprising: a compression unit configured to handle, in encoded video data encoded by pixel unit, a predetermined number of continuous pieces of pixel data as a differential-data-generating unit, the predetermined number being two or more, to cause the first piece of pixel data in the differential-data-generating unit to pass through, and to transform the pieces of pixel data other than the first piece of pixel data into pieces of differential data to thereby generate compressed video data, each of the pieces of differential data indicating a change amount from the preceding piece of pixel data in one of a positive direction and a negative direction; and a sending unit configured to send the compressed video data generated by the compression unit.

According to the video sending apparatus according to the first aspect of the present disclosure, the differential data between continuous two pieces of pixel data is expressed only by a change amount in the positive direction. As a result, it is not necessary to provide a sign bit indicating the positive/negative direction of the differential data. As a result, the transmission bit amount may be reduced.

The compression unit may be configured to compress the transformed differential data by using a non-linear compression-transform property. As a result, the transmission bit amount may further be reduced.

The compression unit may be configured to compress the differential data by using a non-linear compression-transform property, in which the closer to the end of the range of the differential data, the higher the allocated resolution. As a result, both a transform error of a small change amount and a transform error of a large change amount may be reduced. The transform error of a small change amount is relatively likely to be caught by the human sight. The transform error of a large change amount leads to a video ringing.

The compression unit may be configured to reconstitute pieces of pixel data based on the pieces of differential data, and to transform the pieces of pixel data other than the first piece of pixel data in the differential-data-generating unit into pieces of differential data, each of the pieces of differential data indicating a change amount from the reconstituted preceding piece of pixel data in one of a positive direction and a negative direction. As a result, in a differential-data-generating unit, transform errors, which may be included in the differential data, may be limited to an error occurred in one compression-transform. That is, error accumulation may be avoided.

The sending unit may be configured to divide the compressed video data into a plurality of channels, and to send the divided compressed video data simultaneously. As a result, a transmission bit amount for each channel may be reduced greatly.

The compression unit may be configured to reconstitute pixel data based on the differential data, to detect a change of the highest bit of the reconstituted pixel data from an original pixel data, and to correct the compressed differential data based on the detection result. As a result, it is possible to prevent the transmitted pixel data value departing from the normal value greatly because of the fact that 0 and the maximum value as differential data values are adjacent values and because of compression-transform errors of differential data.

According to a second aspect of the present disclosure, there is provided a video receiving apparatus, comprising: a receiving unit configured to receive video data for transmission from a video sending apparatus, the video sending apparatus being configured to handle, in encoded video data encoded by pixel unit, a predetermined number of continuous pieces of pixel data as a differential-data-generating unit, the predetermined number being two or more, to cause the first piece of pixel data in the differential-data-generating unit to pass through, to transform the pieces of pixel data other than the first piece of pixel data into pieces of differential data to thereby generate compressed video data, each of the pieces of differential data indicating a change amount from the preceding piece of pixel data in one of a positive direction and a negative direction, and to send the compressed video data, and to reverse-transform the video data for transmission into the compressed video data; and a decompression unit configured to cause, in the compressed video data, the first piece of pixel data in the differential-data-generating unit to pass through, to decompress the pieces of differential data, and to add a preceding piece of pixel data to each of the pieces of decompressed differential data to thereby reconstitute the pieces of pixel data other than the first piece of pixel data to thereby reconstitute the encoded video data.

The video receiving apparatus is capable of decoding the compressed video data encoded by the video sending apparatus according to the first aspect of the present disclosure.

According to a third aspect of the present disclosure, there is provided a video sending method, comprising: handling, in encoded video data encoded by pixel unit, a predetermined number of continuous pieces of pixel data as a differential-data-generating unit, the predetermined number being two or more; causing the first piece of pixel data in the differential-data-generating unit to pass through; transforming the pieces of pixel data other than the first piece of pixel data into pieces of differential data to thereby generate compressed video data, each of the pieces of differential data indicating a change amount from the preceding piece of pixel data in one of a positive direction and a negative direction; and sending the compressed video data.

As described above, according to the present disclosure, it is possible to reduce the transmission bit amount and to increase the video transmission stability.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing the configuration of a video transmission system according to a first embodiment of the present disclosure;

FIG. 2 is a block diagram showing the configuration of a video sending apparatus in the video transmission system of FIG. 1;

FIG. 3 is a block diagram showing the configuration of an encoder of the video sending apparatus of FIG. 2;

FIG. 4 is a diagram showing a typical method of expressing differential data;

FIG. 5 is a diagram showing a method of expressing differential data of this embodiment;

FIG. 6 is a graph showing a typical non-linear compression-transform property in the past;

FIG. 7 is a graph showing an example of a non-linear compression-transform property employed in this embodiment;

FIG. 8 is a diagram for explaining operations of the encoder;

FIG. 9 is a block diagram showing the configuration of a video receiving apparatus in the video transmission system according to the first embodiment of the present disclosure;

FIG. 10 is a block diagram showing the configuration of a decoder of the video receiving apparatus of FIG. 9;

FIG. 11 is a diagram for explaining operations of the decoder;

FIG. 12 is a block diagram showing the configuration of an encoder of Modified Example 1;

FIG. 13 is a diagram for explaining an effect of a compression-transform error;

FIG. 14 is a diagram for explaining another effect of a compression-transform error; and

FIG. 15 is a block diagram showing the configuration of an encoder of Modified Example 2.

### DETAILED DESCRIPTION OF EMBODIMENTS

Hereinafter, an embodiment of the present disclosure will be described with reference to the drawings.

### First Embodiment

This embodiment will be described in the following order.

1. Video transmission system

2. Configuration of video sending apparatus

3. Configuration of encoder

4. Operations of encoder

5. Configuration of video receiving apparatus

6. Configuration of decoder

7. Operations of decoder

[1. Video Transmission System]

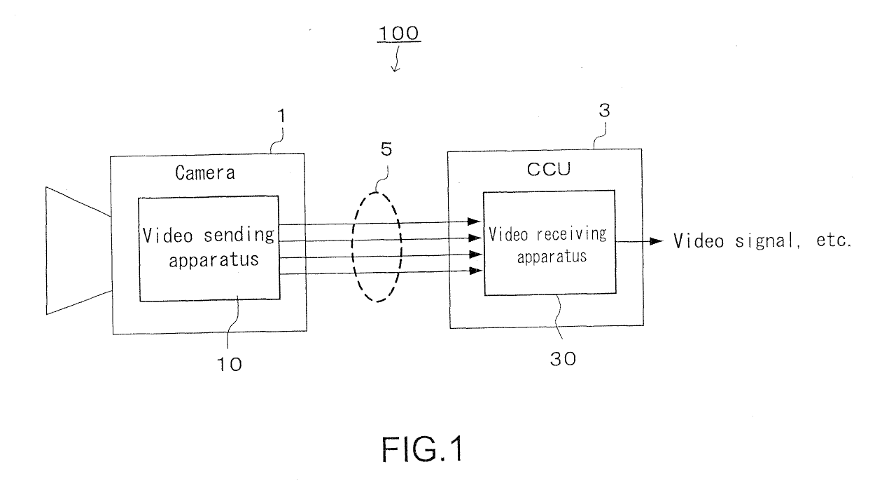

FIG. 1 is a block diagram showing the configuration of a video transmission system 100 according to a first embodiment of the present disclosure. The video transmission system 100 includes a video sending apparatus 10 and a video receiving apparatus 30.

The outline of the video sending apparatus 10 will be described.

The video sending apparatus 10 is embedded in, for example, a camera 1 or the like. The video sending apparatus 10 encodes an analog composite signal (VBS), a component signal, and the like picked by an image pickup unit of the camera, and compresses the encoded video data. The video sending apparatus 10 divides the entire compressed video data into N channels, and transmits them. As a result, the video sending apparatus 10 may reduce a transmission rate for one channel. Therefore, even if a signal is attenuated due to a long-distance transmission, a video transmission insusceptible to noise is realized. The number N of channels is 2 or more, and is selected according to various conditions such as a transmission distance and a total transmission rate.

The video sending apparatus 10 encodes a video signal and compresses the encoded video data as follows.

The video sending apparatus 10 reads a video signal by the unit of pixel, quantizes the video signal, and encodes the video signal to thereby obtain M-bit pixel data. The video sending apparatus 10 handles continuous P pieces of pixel data as one “differential-data-generating unit”. The video sending apparatus 10 causes the first piece of pixel data in the differential-data-generating unit to pass through as it is. The video sending apparatus 10 obtains differential data (M bits) between each of the pieces of pixel data other than the first piece of pixel data and the preceding piece of pixel data. The video sending apparatus 10 compresses the differential data into (M−J)-bit differential data. As a result, one piece of pixel data and (P−1) pieces of differential data are obtained for each differential-data-generating unit.

The video sending apparatus 10 expresses the differential between the continuous two pieces of pixel data only in a positive change amount, in order to be capable of expressing the differential data by the number of bits as small as possible. As a result, it is not necessary to use a sign bit. Therefore, the number of entire transmission bits may be reduced.

Further, the video sending apparatus 10 employs a non-linear compression-transform property, in a case of compressing M-bit differential data into (M−J)-bit data. According to the non-linear compression-transform property, the closer to the end of the possible range of the differential data, the higher the allocated resolution. As a result, transform errors of the differential data in the vicinity of 0 and in the vicinity of the maximum value may be minimized.

The video sending apparatus 10 divides compressed video data for each channel into a plurality of channels. The video sending apparatus 10 adds a CRC code to the compressed video data. The video sending apparatus 10 transforms the compressed video data into a signal sequence for cable transmission to thereby obtain video data for transmission. The video sending apparatus 10 transmits the signal sequence. As camera cables 5, for example, coaxial cables or the like are used.

Next, the outline of the video receiving apparatus 30 will be described.

The video receiving apparatus 30 is mounted in, for example, a camera control Unit (CCU) 3 or the like. The video receiving apparatus 30 receives the video data for transmission for each channel from the above-mentioned camera 1 via the plurality of camera cables 5. The video receiving apparatus 30 reverse-transforms the video data into compressed video data. After that, the video receiving apparatus 30 detects data errors by using the CRC code. The video receiving apparatus 30 joins the compressed video data for the respective channels into one piece of data. The video receiving apparatus 30 decompresses the joined compressed video data to thereby obtain the original encoded video data.

When the video receiving apparatus 30 decompresses the received compressed video data, the video receiving apparatus 30 performs the following processing.

The video receiving apparatus 30 causes M-bit pixel data for each differential-data-generating unit to pass through. Meanwhile, the video receiving apparatus 30 decompresses (M−J)-bit differential data into M-bit differential data by using the reverse property of the above-mentioned non-linear compression-transform property. The video receiving apparatus 30 adds the decompressed M-bit differential data to the preceding pixel data to thereby reconstitute the original pixel data.

[2. Configuration of the Video Sending Apparatus 10]

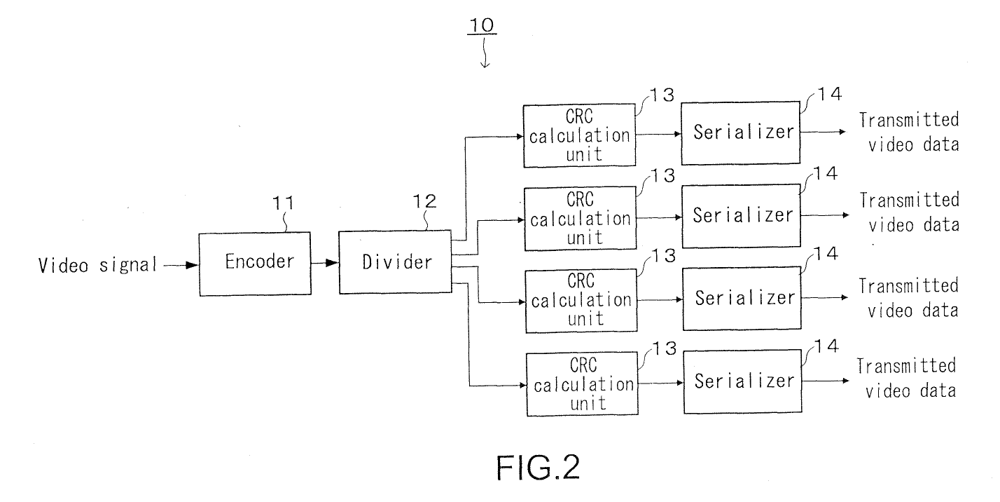

FIG. 2 is a block diagram showing the configuration of the video sending apparatus 10 of the video transmission system 100 of FIG. 1.

The video sending apparatus 10 includes an encoder 11, a divider 12, N number of CRC (Cyclic Redundancy Check) calculation units 13, and N number of serializers 14. Note that N is 4 in FIG. 2. The encoder 11 functions as “compression unit”. The divider 12, the N number of CRC calculation units 13, and the N number of serializers 14 function as “sending unit”.

The encoder 11 reads the input video signal by the unit of pixel, quantizes the signal, and encodes the signal to thereby obtain M-bit pixel data. The encoder 11 handles continuous P pieces of pixel data in the encoded video data as one differential-data-generating unit. The encoder 11 causes the first piece of pixel data in the differential-data-generating unit to pass through as it is. The encoder 11 obtains differential data between each of the pieces of pixel data other than the first piece of pixel data and the preceding piece of pixel data. The encoder 11 compresses the differential data into (M−J)-bit differential data to thereby generate compressed video data.

The divider 12 divides the compressed video data obtained by the encoder 11 into N pieces. The data is divided into N pieces in order not to divide one differential-data-generating unit into a plurality of channels, and in order to make the transmission rate for each channel equal as much as possible.

Each of the N number of CRC calculation units 13 adds a CRC code to the compressed video data divided for each channel.

Each of the N number of serializers 14 transforms the compressed video data for each channel, to which the CRC code is added, to a signal sequence having a format suitable for cable transmission, and sends the video data.

[3. Configuration of the Encoder 11]

Next, the configuration of the encoder 11 will be described in detail.

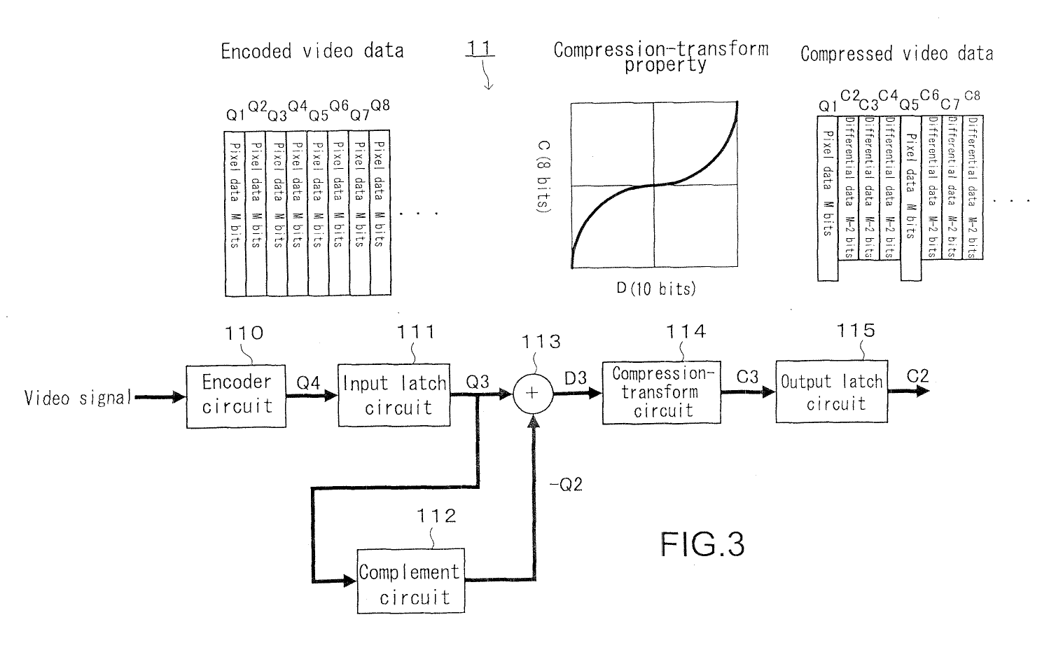

FIG. 3 is a block diagram showing the configuration of the encoder 11.

The encoder 11 includes an encoder circuit 110, an input latch circuit 111, a complement circuit 112, an adder circuit 113, a compression-transform circuit 114, and an output latch circuit 115. Note that, if encoded video data is input in the video sending apparatus 10 from the outside, the encoder 11 does not include the encoder circuit 110.

FIG. 3 shows the state where the encoder 11 processes the third pixel data Q3. Hereinafter, the continuous pieces of pixel data are referred to as, for example, “pixel data Q(n−1)”, “pixel data Qn”, and “pixel data Q(n+1)”. The order of other kinds of data will be similarly represented.

The encoder circuit 110 encodes a video signal by the unit of pixel, and outputs M-bit pixel data.

The encoder circuit 110 inputs the respective M-bit pixel data Q1, Q2, Q3, Q4, Q5, Q6, Q7, Q8 . . . in the input latch circuit 111 in this order. The input latch circuit 111 latches the input video data for the unit of pixel data Qn. The input latch circuit 111 supplies the pixel data Qn to the complement circuit 112 and the adder circuit 113 at the timing when the next pixel data Q(n+1) is input.

The complement circuit 112 adds “1” to the complement of the pixel data Qn supplied from the input latch circuit 111 to thereby calculate the bit sequence −Qn. The complement circuit 112 latches the data, and outputs the data to the adder circuit 113.

The adder circuit 113 adds the pixel data Qn input from the input latch circuit 111 to the bit sequence −Q(n−1), which is generated by the complement circuit 112 based on the preceding pixel data Q(n−1), to thereby generate M-bit differential data Dn. The M-bit differential data Dn does not require a sign bit. The adder circuit 113 outputs the differential data Dn to the compression-transform circuit 114.

Note that the adder circuit 113 causes the pixel data Qn sequentially supplied from the input latch circuit 111 to pass through as it is every P times, and outputs the pixel data Qn to the compression-transform circuit 114. Here, the differential-data-generating unit is the continuous P pieces of pixel data starting from the pixel data Qn, which is caused to pass through the adder circuit 113 as it is.

The differential data that does not require a sign bit will be described.

In this embodiment, in order to exclude a sign bit from the differential data expression, the following method is employed. That is, differential data is expressed by a change amount from a preceding pixel data value in the positive direction.

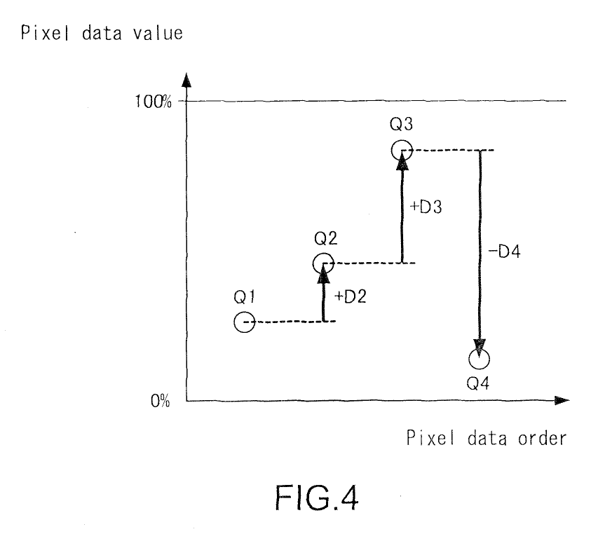

FIG. 4 is a diagram showing a typical method of expressing differential data.

Here, the vertical axis represents a pixel data value, and the horizontal axis represents a pixel data order direction. Q1, Q2, Q3 and Q4 are pixel data values, and each of +D2, +D3, and −D4 is differential data between the continuous two pieces of pixel data.

According to the typical method, differential data is expressed by the change amount from the preceding pixel data in a positive/negative direction. Therefore, differential data is expressed by (M+1) bits. (M+1) is obtained by adding 1 bit representing the change direction to the bit number expressing the pixel data value. That is, in the case of using differential data, the transmission bit amount increases compared to the case where the pixel data is used as it is.

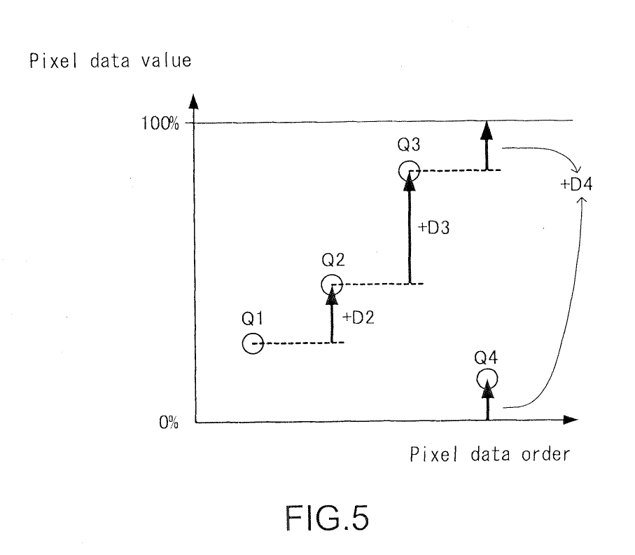

FIG. 5 is a diagram showing the method of expressing differential data according to this embodiment.

As shown in FIG. 5, according to this embodiment, in order to exclude a sign bit from the differential data expression, differential data is expressed only by a change amount in the positive direction. For example, in the typical example shown in FIG. 4, the differential data (−D4) between the image data Q3 and the image data Q4 is expressed by a negative value. To the contrary, in this embodiment, the differential data (+D4) is expressed by the sum of the change amount from the value of the pixel data Q3 to the possible maximum pixel data value, and the change amount from 0 to the value of the pixel data Q4. As described above, differential data is expressed by a change amount in the positive direction. Therefore, it is not necessary to use a sign bit expressing a positive/negative direction of a change amount.

Description will be made with reference to FIG. 3 again. The compression-transform circuit 114 causes the first piece of pixel data Qn (note that n=1, 5) in the differential-data-generating unit to pass through as it is. The compression-transform circuit 114 compression-transforms the successive M-bit differential data Dn (note that n=2, 3, 4, 6, 7, 8) into (M−J)-bit differential data Cn (note that n=2, 3, 4, 6, 7, 8).

Further, in the compression-transform by the compression-transform circuit 114, a non-linear compression-transform property is employed. According to the non-linear compression-transform property, the closer to the end of the possible range of the differential data, the higher the allocated resolution.

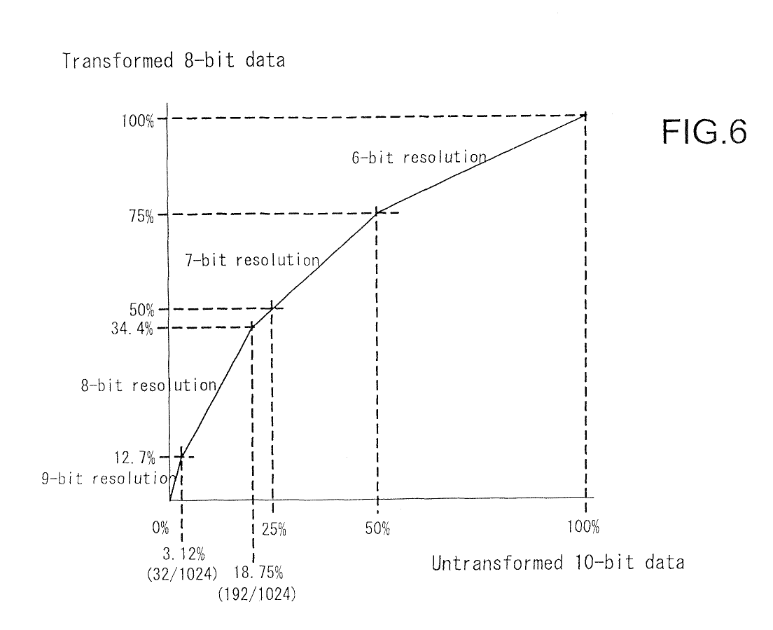

FIG. 6 is a graph showing a typical non-linear compression-transform property in the past.

Note that the typical non-linear compression-transform property shows the following property. That is, 10-bit data including a sign bit is transformed into 8-bit data. In the typical non-linear compression-transform property, the smaller the change amount value, the higher the allocated resolution. This is because the human sight hardly recognizes errors when images greatly change. However, in a case where the resolution of the range, in which a change amount value is small, is increased, the resolution of the range, in which the change amount value is large, is sacrificed. In this situation, a video ringing may occur resulting from a compression-transform error of differential data of a large change amount. An example of such an error is a situation where the pixel data value changes from the value in the vicinity of 0 to the value in the vicinity of the maximum value.

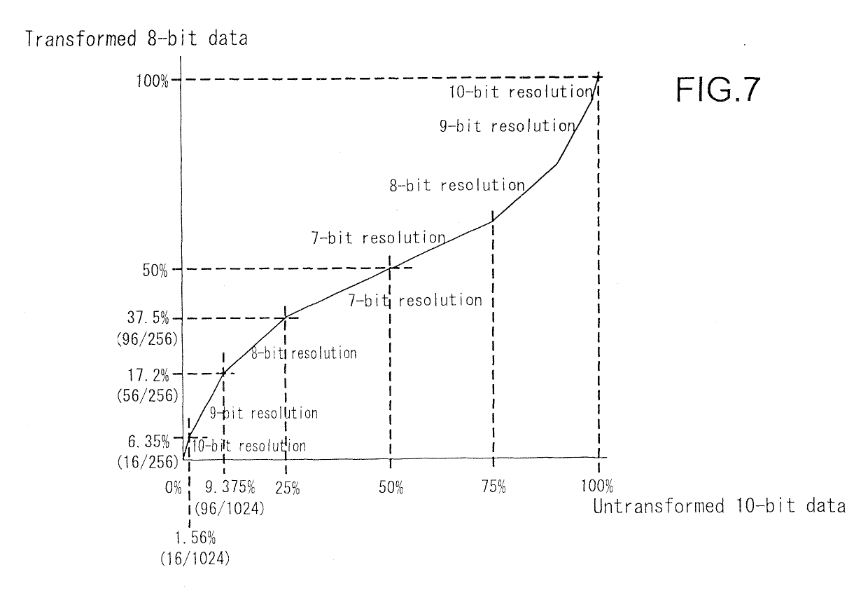

FIG. 7 is a graph showing an example of a non-linear compression-transform property employed in this embodiment. In this embodiment, there is employed a non-linear compression-transform property in which the closer to the end of the range of the differential data Dn, the higher the allocated resolution. That is, in the compression-transform property, for example, 7-bit resolution is given to the middle range (25% to 75%) in the range of the possible differential data value. 8-bit resolution is given to the ranges next to and outside of the middle range. 9-bit resolution is given to the ranges next to and outside of the ranges, to which 8-bit resolution is given. 10-bit resolution is given to the most outside ranges. By using such a non-linear compression-transform property, in a case where a change amount is in the vicinity of 0 and in the vicinity of the maximum value, the compression-transform accuracy of differential data may be increased. Specifically, by increasing the compression-transform accuracy in the vicinity of the maximum value, occurrence of a video ringing may be reduced.

With reference to FIG. 3 again, the output latch circuit 115 latches the pixel data Qn and the differential data Cn supplied from the compression-transform circuit 114. The pixel data Qn and the differential data Cn are read out at the timing when the next data is input.

[4. Operations of the Encoder 11]

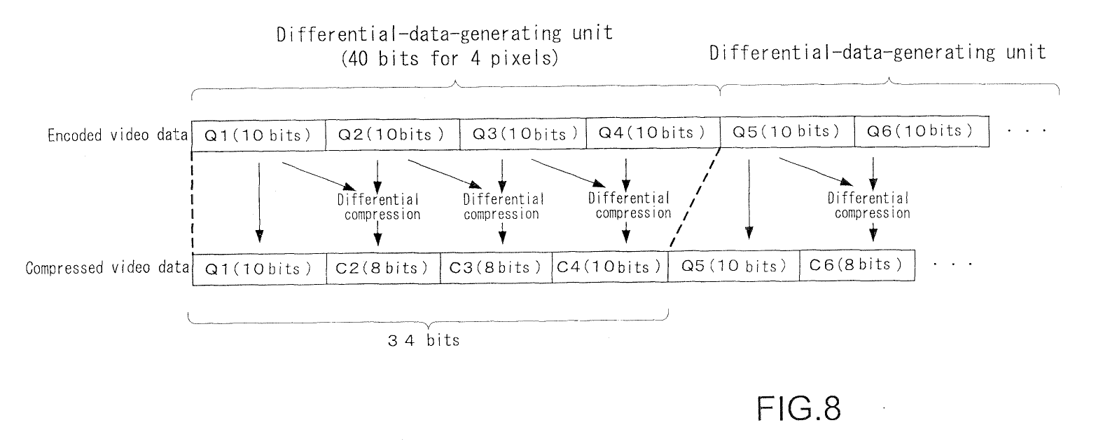

FIG. 8 is a diagram for explaining the operations of the encoder 11.

Let's say P is 4, M is 10, and J is 2.

(Processing to First Pixel Data Q1)

The input latch circuit 111 latches the first pixel data Q1 output from the encoder circuit 110. After that, the complement circuit 112 and the adder circuit 113 read out the first pixel data Q1 at the timing when the next pixel data Q2 is input. The adder circuit 113 and the compression-transform circuit 114 cause the first pixel data Q1 to pass through as it is. The compression-transform circuit 114 outputs the first pixel data Q1 to the output latch circuit 115. The pixel data Q1 latched by the output latch circuit 115 is read out at the timing when the next differential data C2 is input in the output latch circuit 115.

(Processing to Second Pixel Data Q2)

The input latch circuit 111 latches the second pixel data Q2 output from the encoder circuit 110. After that, the input latch circuit 111 outputs the second pixel data Q2 to the complement circuit 112 and the adder circuit 113 at the timing when the next pixel data Q3 is input. The adder circuit 113 adds the second pixel data Q2 to the bit sequence −Q1 to thereby generate 10-bits differential data D2. The bit sequence −Q1 is generated by the complement circuit 112 based on the first pixel data Q1. The adder circuit 113 outputs the differential data D2 to the compression-transform circuit 114.

Note that the complement circuit 112 outputs the bit sequence −Qn to the adder circuit 113. The bit sequence −Qn is obtained by adding “1” to the complement of the pixel data Qn input from the input latch circuit 111. For example, in a case where the pixel data “h000” is input in the complement circuit 112, “h3FF” is obtained as the complement. “1” is added to “h3FF”, and the result is “h400”. Here, a carried upper bit is ignored, whereby the complement circuit 112 outputs “h000”. Further, in the addition by the adder circuit 113, in a case where data overflows 10 bits, the carried upper one bit is abandoned, and the lower 10-bit data is used as addition result.

The compression-transform circuit 114 compression-transforms the 10-bit differential data D2 obtained as described above into the 8-bit differential data C2 by using the above-mentioned non-linear coding compression-transform property. The 8-bit differential data C2 is output to the output latch circuit 115. The 8-bit differential data C2 is read out from the output latch circuit 115 at the timing when the next differential data C3 is input.

The third pixel data Q3 and the fourth pixel data Q4 output from the encoder circuit 110 are processed similar to the second pixel data Q2. As a result, the 8-bit differential data D3 and the 8-bit differential data D4 are obtained, and output to the output latch circuit 115. The 8-bit differential data D3 and the 8-bit differential data D4 are read out from the output latch circuit 115 at the timing when the next data is input.

Here, one differential-data-generating unit includes 4 pieces (P=4) of pixel data. Therefore, the next fifth pixel data Q5 is caused to pass through as it is similar to the case of the first pixel data Q1. Further, the sixth pixel data Q6 to the eighth pixel data Q8 are processed similar to the case of the second pixel data Q2 to the fourth pixel data Q4. As a result, the 8-bit differential data D6 to the 8-bit differential data D8 are obtained, and output from the output latch circuit 115.

As a result, in the case of M is 10, J is 2, and P is 4, the pixel data included in one differential-data-generating unit is 40 bits (10 bits×4). To the contrary, after the compression by the encoder 11, the pixel data is compressed to 34 bits (10+(8×3)).

[5. Configuration of the Video Receiving Apparatus 30]

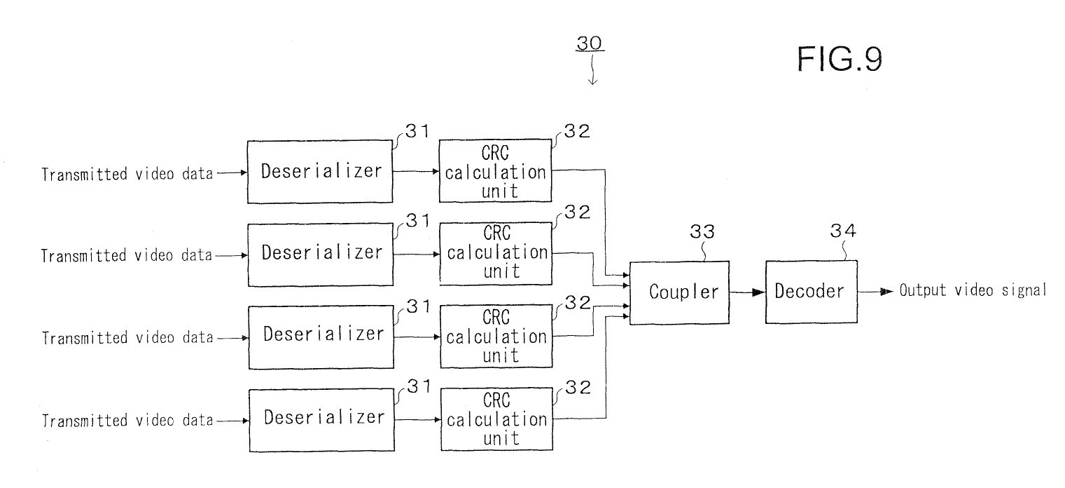

FIG. 9 is a block diagram showing the configuration of the video receiving apparatus 30 of the video transmission system 100 according to the first embodiment of the present disclosure.

The video receiving apparatus 30 includes N number of deserializers 31, N number of CRC calculation units 32, a coupler 33, and a decoder 34. Here, the N number of deserializers 31, the N number of CRC calculation units 32, and the coupler 33 function as “receiving unit”. The decoder 34 functions as “decompression unit”.

Each of the N number of deserializers 31 reverse-transforms the received compressed video data for each channel from the signal sequence in the format suitable for transmission to the signal sequence of the original compressed video data.

Each of the N number of CRC calculation units 32 performs error detection by using the CRC code with respect to the compressed video data for each channel output from the deserializer 31.

The coupler 33 couples the respective pieces of compressed video data output from the N number of respective CRC calculation units 32 to reconstitute the sequence before the division by the divider 12.

The decoder 34 decompresses the compressed video data coupled by the coupler 33 to obtain the original encoded video data, and decodes the original encoded video data. More specifically, the decoder 34 causes the first piece of pixel data Qn in the differential-data-generating unit to pass through as it is. The decoder 34 decompresses the successive (M−J)-bit differential data Cn into M-bit differential data. The decoder 34 adds the M-bit differential data to the preceding pixel data to thereby reconstitute the original encoded video data. Finally, the decoder 34 decodes the original encoded video data, and outputs the video signal.

[6. Configuration of the Decoder 34]

Next, the configuration of the decoder 34 will be described in detail.

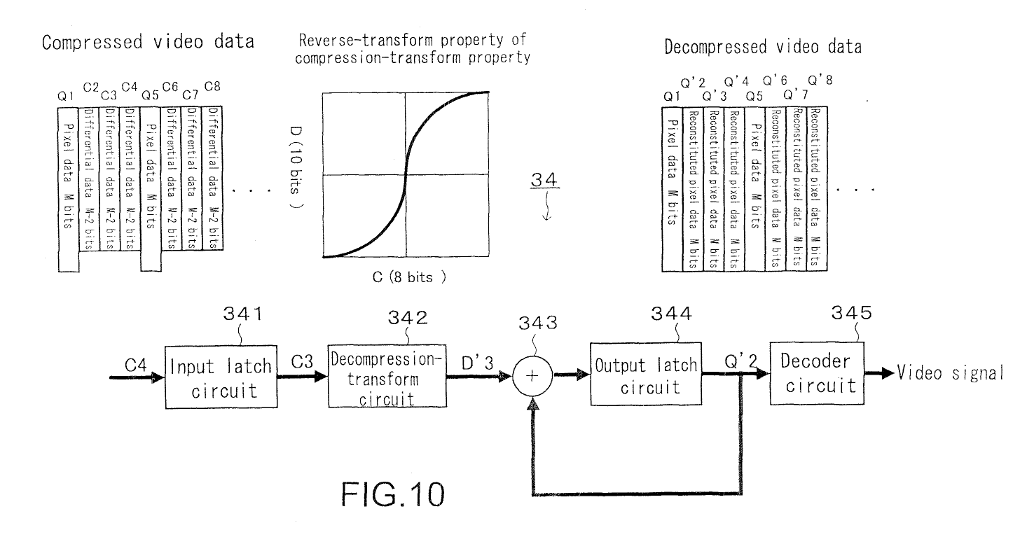

FIG. 10 is a block diagram showing the configuration of the decoder 34.

The M-bit pixel data Q1, the respective (M−J)-bit differential data C2, C3, C4, the M-bit pixel data Q5, and the respective (M−J)-bit differential data C6, C7, C8 are input in the decoder 34 as compressed video data in this order. Note that, FIG. 10 shows the state where the decoder 34 processes the third differential data C3.

The decoder 34 includes an input latch circuit 341, a decompression-transform circuit 342, an adder circuit 343, an output latch circuit 344, and a decoder circuit 345.

The input latch circuit 341 latches the input M-bit pixel data Qn (n=1, 5) and (M−J)-bit differential data Cn (n=2, 3, 4, 6, 7, 8). The decompression-transform circuit 342 reads out the data latched by the input latch circuit 341 at the timing when the next data is input.

The decompression-transform circuit 342 causes the data read out from the input latch circuit 341 to pass through as it is every P times, to thereby output the first piece of pixel data Qn in the differential-data-generating unit to the adder circuit 343 as it is. The decompression-transform circuit 342 decompresses the differential data Cn into M-bit differential data Dn by using the reverse-transform property of the compression-transform property shown in FIG. 7.

The adder circuit 343 causes the data output from the decompression-transform circuit 342 to pass through as it is every P times. As a result, the adder circuit 343 outputs the first piece of pixel data Qn in the differential-data-generating unit to the output latch circuit 344 as it is. The adder circuit 343 adds the differential data Dn to the preceding pixel data Q′(n−1) to thereby reconstitute the pixel data Q′n. The adder circuit 343 outputs the pixel data Q′n to the output latch circuit 344.

The output latch circuit 344 latches the pixel data Qn and the reconstituted pixel data Q′n, which are output from the adder circuit 343. The output latch circuit 344 supplies the pixel data Qn and the reconstituted pixel data Q′n to the decoder circuit 345 and the adder circuit 343 at the timing when the next data is input.

The decoder circuit 345 decodes the pixel data Qn and Q′n read out from the output latch circuit 344 to thereby reconstitute the video signal.

[7. Operations of the Decoder 34]

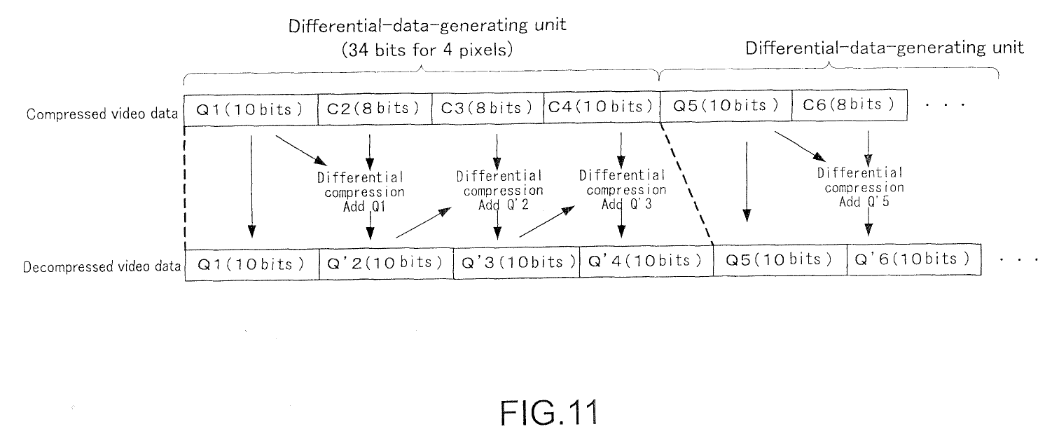

FIG. 11 is a diagram for explaining the operations of the decoder 34.

Let's say P is 4, M is 10, and j is 2.

The 10-bit pixel data Q1, the respective 8-bit differential data C2, C3, C4, the 10-bit pixel data Q5, and the respective 8-bit differential data C6, C7, C8 are input in the decoder 34 in this order.

(Processing to First Pixel Data Q1)

The input latch circuit 341 latches the first pixel data Q1 input in the decoder 34. After that, the decompression-transform circuit 342 reads out the first pixel data Q1 at the timing when the next differential data C2 is input. The pixel data Q1 read out by the decompression-transform circuit 342 passes through the decompression-transform circuit 342 as it is. The pixel data Q1 is input in the adder circuit 343, and passes through the adder circuit 343 as it is. The output latch circuit 344 latches the pixel data Q1. After that, the output latch circuit 344 reads out the pixel data Q1 at the timing when the next pixel data is input.

(Processing to Next Differential Data C2)

The input latch circuit 341 latches the first differential data C2 input in the decoder 34. After that, the decompression-transform circuit 342 reads out the first differential data C2 from the input latch circuit 341 at the timing when the next differential data C3 is input. The decompression-transform circuit 342 decompression-transforms the 8-bit differential data C2 read out from the input latch circuit 341 into 10-bit differential data D2 by using the reverse-transform property of the compression-transform property shown in FIG. 7. The adder circuit 343 adds the 10-bit differential data D2 to the first pixel data Q1 to thereby reconstitute pixel data Q′2. The adder circuit 343 outputs the pixel data Q′2 to the output latch circuit 344 and the adder circuit 343. Note that, in a case where the addition result by the adder circuit 343 overflows 10 bits, the carried upper one bit is abandoned, and the lower 10-bit data is output to the output latch circuit 344 and the adder circuit 343 as the addition result.

(Processing to Next Differential Data C3)

The input latch circuit 341 latches the next differential data C3 input in the decoder 34. After that, the decompression-transform circuit 342 reads out the differential data C3 from the input latch circuit 341 at the timing when the next differential data C4 is input. The decompression-transform circuit 342 decompression-transforms the 8-bit differential data D3 read out from the input latch circuit 341 into 10-bit differential data D3 by using the reverse-transform property of the compression-transform property shown in FIG. 7. The adder circuit 343 adds the 10-bit differential data D3 to the reconstituted preceding pixel data Q′2 to thereby reconstitute the pixel data Q′3. The adder circuit 343 outputs the pixel data Q′3 to the output latch circuit 344 and the adder circuit 343. The next differential data D4 is processed similar to the differential data D3.

As described above, the processing to one differential-data-generating unit is completed. The processing to the next differential-data-generating unit is repeated in the similar manner.

As described above, according to the video transmission system 100 of this embodiment, the following effects may be obtained.

1. The differential data between continuous two pieces of pixel data is expressed only by a change amount in the positive direction. As a result, it is not necessary to provide a sign bit indicating the positive/negative direction of the differential data. As a result, the transmission bit amount may be reduced.

2. M-bit differential data is compressed to (M−J)-bit differential data by using a non-linear compression-transform property. The (M−J)-bit differential data is transmitted. As a result, the transmission bit amount may further be reduced.

3. The video sending apparatus 10 divides compressed video data obtained by the encoder 11 into a plurality of channels, and transmits the compressed video data in parallel. As a result, a transmission bit amount for each channel may be reduced greatly.

4. The compression-transform circuit 114 of the video sending apparatus 10 compression-transforms differential data by using a non-linear compression-transform property in which the closer to the end of the range the differential data Dn, the higher the allocated resolution. As a result, a transmission bit amount may be reduced. In addition, both a transform error of a small change amount and a transform error of a large change amount may be reduced. The transform error of a small change amount is relatively likely to be caught by the human sight. The transform error of a large change amount leads to a video ringing.

Note that, in the above-mentioned embodiment, in order to exclude a sign bit from the differential data expression, there is employed a method of expressing differential data by a change amount from the preceding pixel data value in the positive direction. It is needless to say that there may be employed, in order to exclude a sign bit from the differential data expression, a method of expressing differential data by a change amount from the preceding pixel data value in the negative direction.

### Modified Example 1

By the way, in the first embodiment, as shown in FIG. 11, the second differential data D2 in one differential-data-generating unit includes a compression-transform error, which occurs when the differential data D2 is generated. The third differential data D3 includes compression-transform errors, which occur when the second differential data D2 and the third differential data D3 are generated, respectively. The fourth differential data D4 includes compression-transform errors, which occur when the second differential data D2, the third differential data D3, and the fourth differential data D4 are generated, respectively. That in one differential-data-generating unit, the latter the differential data, the more the accumulated compression-transform error.

Modified Example 1 relates to an encoder capable of preventing such a compression-transform error accumulation.

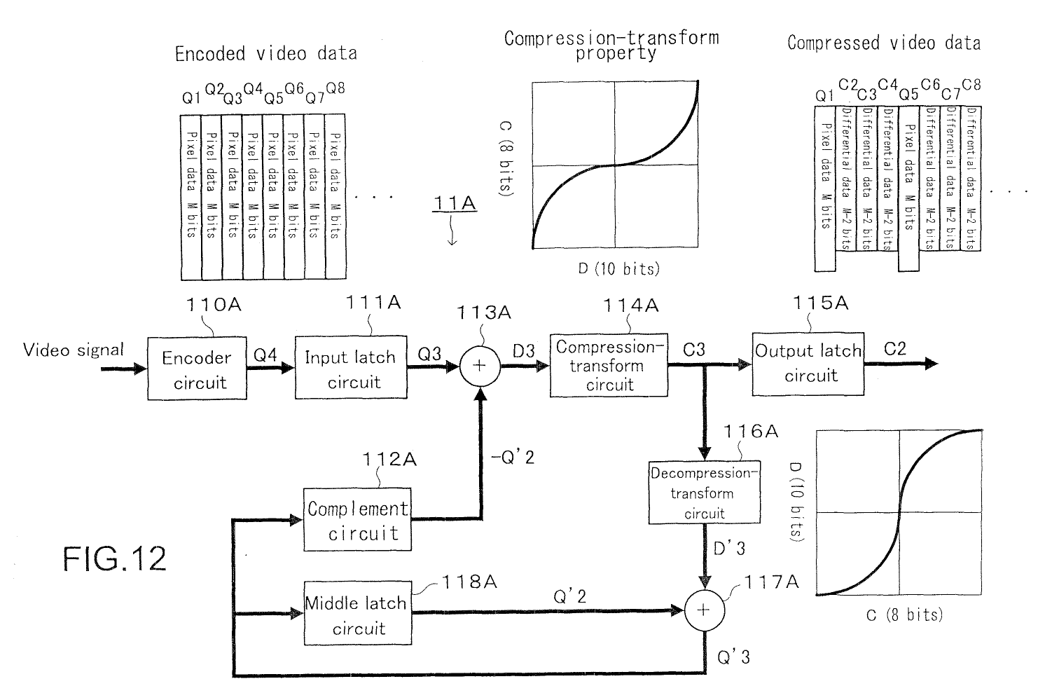

FIG. 12 is a block diagram showing the configuration of an encoder 11A of Modified Example 1.

The encoder 11A includes an encoder circuit 110A, an input latch circuit 111A, a complement circuit 112A, a first adder circuit 113A, a compression-transform circuit 114A, an output latch circuit 115A, a decompression-transform circuit 116A, a second adder circuit 117A, and a middle latch circuit 118A.

The respective M-bit pixel data Q1, Q2, Q3, Q4, Q5, Q6, . . . are input in the encoder 11A in this order. Note that FIG. 12 shows a state where the encoder 11A processes the third pixel data Q3. Hereinafter, the continuous pieces of pixel data will be referred to as “pixel data Q(n−1)”, “pixel data Qn”, “pixel data Q(n+1)”, and the like. The other data orders will be described similarly.

Similar to the input latch circuit 111 of FIG. 3, the input latch circuit 111A latches the M-bit pixel data Qn output from the encoder circuit 110A. The complement circuit 112A and the first adder circuit 113A reads out the pixel data Qn latched by the input latch circuit 111A at the timing when the next pixel data Q(n+1) is input.

The first adder circuit 113A corresponds to the adder circuit 113 of the first embodiment. The first adder circuit 113A adds the pixel data Qn input from the input latch circuit 111A to the bit sequence −Q(n−1), which is generated by the complement circuit 112A based on the preceding pixel data Q(n−1). Alternatively, the first adder circuit 113A adds the pixel data Qn input from the input latch circuit 111A to the bit sequence −Q′ (n−1), which is generated by the complement circuit 112A based on the preceding reconstituted pixel data Q′(n−1). As a result, the first adder circuit 113A generates M-bit differential data Dn requiring no sign bit, and outputs the M-bit differential data Dn to the compression-transform circuit 114A.

Note that the first adder circuit 113A outputs the pixel data Qn from the input latch circuit 111A to the compression-transform circuit 114A as it is every 1/P times. Here, one differential-data-generating unit is the continuous P pieces of pixel data starting from the pixel data, which passes through the first adder circuit 113A.

The compression-transform circuit 114A corresponds to the compression-transform circuit 114 of the first embodiment. The compression-transform circuit 114A causes the first piece of pixel data Qn in a differential-data-generating unit to pass through as it is. The compression-transform circuit 114A compression-transforms the successive differential data D(n) into (M−J)-bit data Cn.

The decompression-transform circuit 116A causes the first piece of pixel data Qn in the differential-data-generating unit, which is output from the compression-transform circuit 114A, to pass through as it is. The decompression-transform circuit 116A reconstitutes M-bit differential data D′n from the differential data Cn by using the reverse-transform property of the non-linear compression-transform property shown in FIG. 7. The decompression-transform circuit 116A outputs the M-bit differential data D′n to the second adder circuit 117A. Note that the symbol “′” indicates that the differential data is reconstituted data.

The second adder circuit 117A causes the first piece of pixel data Qn, which is output from the decompression-transform circuit 116A, to pass through as it is. The second adder circuit 117A outputs the first piece of pixel data Qn to the complement circuit 112A and the middle latch circuit 118A. Further, the second adder circuit 117A adds the differential data D′n output from the decompression-transform circuit 116A to the preceding pixel data Q(n−1) or the preceding reconstituted pixel data Q′(n−1) read out from the middle latch circuit 118A to thereby reconstitute the pixel data Q′n. The second adder circuit 117A outputs the pixel data Q′n to the complement circuit 112A and the middle latch circuit 118A.

The middle latch circuit 118A latches the pixel data Qn or the pixel data Q′n output from the second adder circuit 117A. The second adder circuit 117A reads out the pixel data Qn or the pixel data Q′n from the middle latch circuit 118A.

The complement circuit 112A adds “1” to the complement of the preceding pixel data Q(n−1), which is output from the second adder circuit 117A, to thereby obtain a bit sequence −Q(n−1). Alternatively, the complement circuit 112A adds “1” to the complement of the preceding reconstituted pixel data Q′(n−1) to thereby obtain a bit sequence −Q′(n−1). The complement circuit 112A outputs the bit sequence −Q(n−1) or the bit sequence −Q′(n−1) to the first adder circuit 113A.

Next, the operations of the encoder 11A of Modified Example 1 will be described.

Let's say P is 4, M is 10, and J is 2.

Let's say 10-bit pixel data Qn is input in the encoder 11A in the order of Q1, Q2, Q3, Q4, Q5, Q6, . . . .

(Processing to First Pixel Data Q1)

First, the input latch circuit 111A latches the first pixel data Q1 input in the encoder 11A. After that, the first adder circuit 113A reads out the first pixel data Q1 at the timing when the next pixel data Q2 is input. The pixel data Q1 read out from the input latch circuit 111A passes through the first adder circuit 113A and the compression-transform circuit 114A as it is. The pixel data Q1 is input in the output latch circuit 115A. After the latch, the output latch circuit 115A outputs the pixel data Q1 at the timing when the next data C2 is input in the output latch circuit 115A. Further, the pixel data Q1, which has passed through the compression-transform circuit 114A, passes through the decompression-transform circuit 116A and the second adder circuit 117A. The pixel data Q1 is output to the complement circuit 112A and the middle latch circuit 118A.

(Processing to Second Pixel Data Q2)

The input latch circuit 111A latches the second pixel data Q2 input in the encoder 11A. After that, the first adder circuit 113A reads out the second pixel data Q2 at the timing when the next pixel data Q3 is input. The second adder circuit 117A adds the input second pixel data Q2 to the bit sequence −Q1, which is generated by the complement circuit 112A based on the first pixel data Q1, to thereby generate 10-bit differential data. The second adder circuit 117A outputs the 10-bit differential data to the compression-transform circuit 114A.

The compression-transform circuit 114A compression-transforms the 10-bit differential data D2 into 8-bit differential data C2 by using the non-linear coding compression-transform property of FIG. 7. The compression-transform circuit 114A outputs the 8-bit differential data C2 to the output latch circuit 115A and the decompression-transform circuit 116A. The output latch circuit 115A latches the differential data C2. The output latch circuit 115A outputs the differential data C2 at the timing when the next data is input in the output latch circuit 115A.

Meanwhile, the decompression-transform circuit 116A decompression-transforms the 8-bit differential data C2 into 10-bit differential data D′2 by using the reverse-transform property of the coding compression-transform property of FIG. 7. The second adder circuit 117A adds the decompression-transformed 10-bit differential data D′2 to the first pixel data Q1 to thereby reconstitute the pixel data Q′2. The second adder circuit 117A outputs the pixel data Q′2 to the complement circuit 112A and the middle latch circuit 118A.

(Processing To Third Pixel Data Q3)

The input latch circuit 112A latches the third pixel data Q3 input in the encoder 11A. After that, the input latch circuit 111A outputs the third pixel data Q3 to the first adder circuit 113A at the timing when the next pixel data Q4 is input. The first adder circuit 113A adds the input third pixel data Q3 to the bit sequence −Q′2, which is generated by the complement circuit 112A based on the pixel data Q′2, to thereby generate 10-bit differential data D3. The first adder circuit 113A outputs the 10-bit differential data D3 to the compression-transform circuit 114A.

The compression-transform circuit 114A compression-transforms the differential data D3 into 8-bit differential data C3 by using the non-linear coding compression-transform property of FIG. 7. The compression-transform circuit 114A outputs the 8-bit differential data C3 to the output latch circuit 115A and the decompression-transform circuit 116A. The output latch circuit 115A latches the differential data C3. The output latch circuit 115A outputs the differential data C3 at the timing when the next data C4 is input in the output latch circuit 115A.

Meanwhile, the decompression-transform circuit 116A decompression-transforms the 8-bit differential data D3 into 10-bit differential data D′3 by using the reverse-transform property of the coding compression-transform property of FIG. 7. The second adder circuit 117A adds the decompression-transformed 10-bit differential data D′3 to the second pixel data Q′2 to thereby reconstitute the pixel data Q′3. The second adder circuit 117A outputs the pixel data Q′3 to the complement circuit 112A and the middle latch circuit 118A.

The fourth pixel data Q4 is processed similar to the processing to the third pixel data Q3.

As described above, in the encoder 11A of Modified Example 1, the decompression-transform circuit 116A decompresses the differential data Cn, which is compression-transformed by the compression-transform circuit 114A, to thereby obtain differential data D′n of the original bit number. The decompression-transform circuit 116A adds the differential data D′n to the preceding image data Q(n−1) or the preceding reconstituted image data Q′(n−1) to thereby reconstitute the pixel data Q′n. The decompression-transform circuit 116A inputs the pixel data Q′n in the complement circuit 112A. As a result, in a differential-data-generating unit, transform errors, which may be included in the differential data Dn, may be limited to an error occurred in one compression-transform. That is, error accumulation may be avoided.

### Modified Example 2

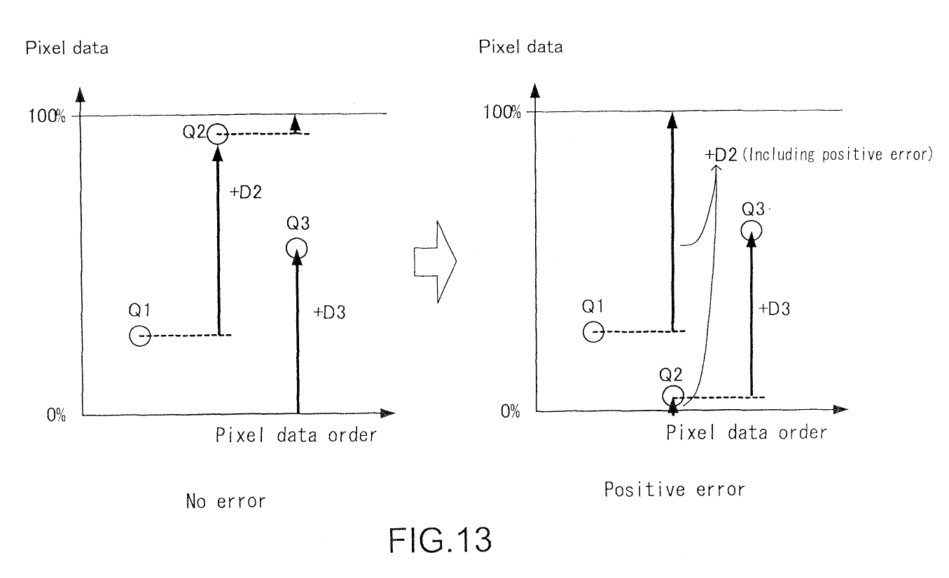

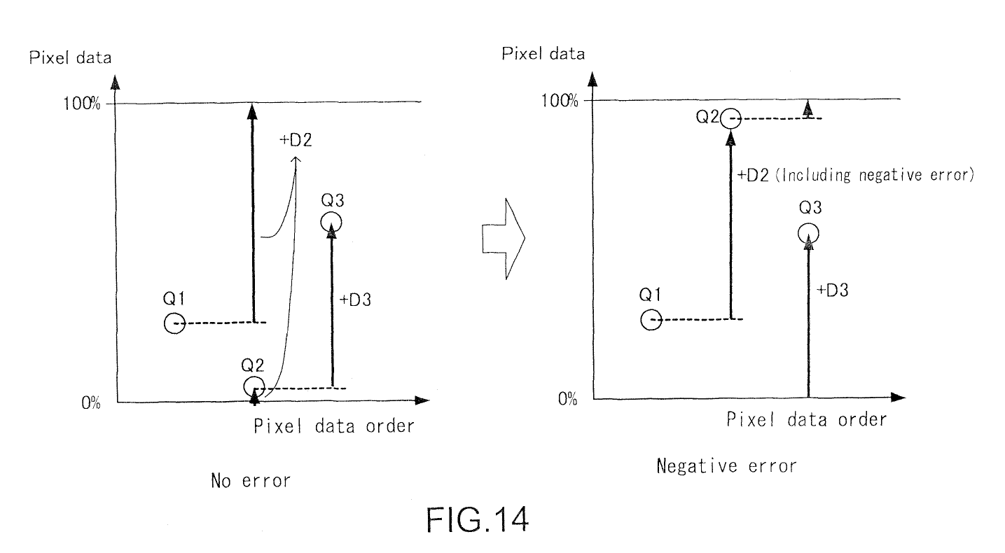

According to the first embodiment, 0 and the maximum value as the differential data Dn values are adjacent values. Therefore, as shown in for example FIG. 13, let's say the value, which is obtained by adding differential data D(n+1) to pixel data Qn, should be a value smaller than the maximum value normally. In this case, if the differential data D(n+1) includes a positive compression-transform error, the value obtained by addition may overflow the maximum value and may be in the vicinity of 0. Further, as shown in FIG. 14, let's say the value, which is obtained by adding the differential data D(n+1) to the pixel data Qn, should be a value that overflows the maximum value and is in the vicinity of 0. In this case, if the differential data D(n+1) includes a negative compression-transform error, the value obtained by addition may be in the vicinity of the maximum value.

Modified Example 2 relates to an encoder which may prevent such problems.

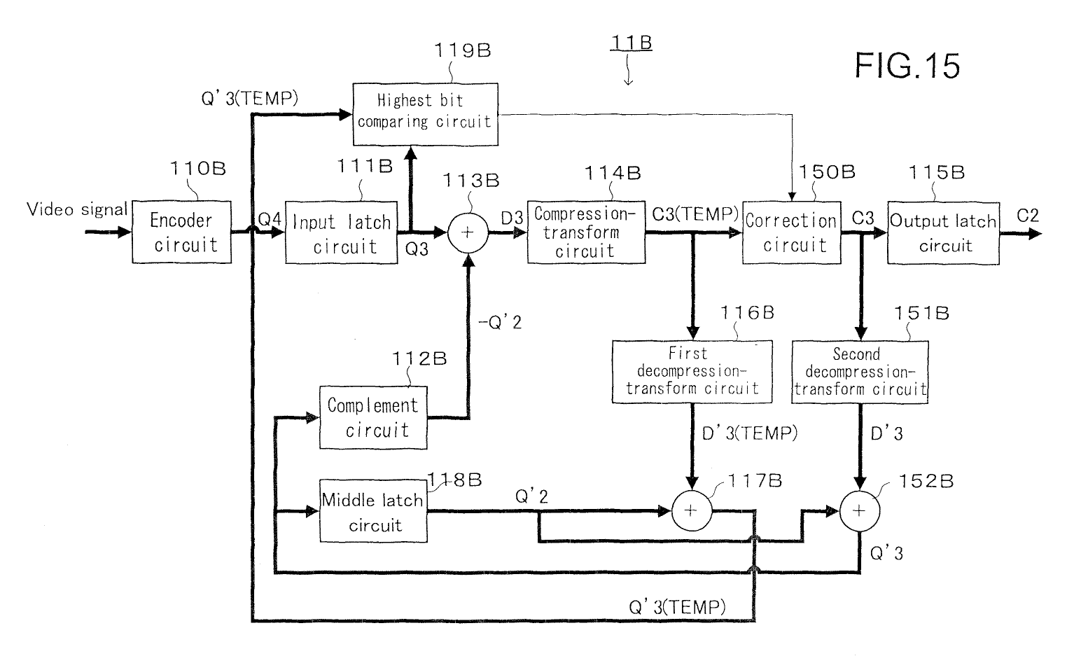

FIG. 15 is a block diagram showing the configuration of an encoder 11B of Modified Example 2.

The encoder 11B includes, in addition to the configuration of the encoder 11A of Modified Example 1 shown in FIG. 11, a highest bit comparing circuit 119B, a correction circuit 150B, a second decompression-transform circuit 151B, and a third adder circuit 152B. Note that the decompression-transform circuit 116A in FIG. 11 corresponds to the first decompression-transform circuit 116B in FIG. 14.

The respective M-bit pixel data Q1, Q2, Q3, Q4, Q5, Q6, . . . are input in the encoder 11B in this order. Note that FIG. 15 shows the state where the encoder 11B processes the third pixel data Q3. Hereinafter, the continuous pieces of pixel data are referred to as, for example, “pixel data Q(n−1)”, “pixel data Qn”, and “pixel data Q(n+1)”. The order of other kinds of data will be similarly represented.

The correction circuit 150B corrects the highest bit of (M−J)-bit differential data Cn(TEMP), which is compression-transformed by the compression-transform circuit 114B, based on the comparison result from the highest bit comparing circuit 119B. Alternatively, the correction circuit 150B causes the highest bit of (M−J)-bit differential data Cn(TEMP) to pass through. Note that “(TEMP)” means an uncorrected value.

The first decompression-transform circuit 116B decompression-transforms the (M−J)-bit differential data Cn(TEMP), which is compression-transformed by the compression-transform circuit 114B, into uncorrected M-bit differential data D′n(TEMP) by using the reverse-transform property of the coding compression-transform property of FIG. 7.

The first decompression-transform circuit 116E outputs the uncorrected M-bit differential data D′n(TEMP). The second adder circuit 117B adds the uncorrected M-bit differential data D′n(TEMP) to the preceding pixel data Q(n−1) or the preceding corrected pixel data Q′(n−1) latched by the middle latch circuit 118B to thereby generate uncorrected pixel data Q′n(TEMP). The second adder circuit 117B outputs the uncorrected pixel data Q′n(TEMP) to the highest bit comparing circuit 119B.

The second decompression-transform circuit 151B decompression-transforms the corrected (M−J)-bit differential data Cn, which has passed through the correction circuit 150B, into M-bit differential data D′n by using the reverse-transform property of the coding compression-transform property of FIG. 7.

The third adder circuit 152B adds the corrected M-bit differential data D′n output from the second decompression-transform circuit 151B to the preceding pixel data Q(n−1) or the preceding corrected pixel data Q′(n−1) latched by the middle latch circuit 118B to thereby generate corrected pixel data Q′n. The third adder circuit 152E outputs the corrected pixel data Q′n to the complement circuit 112B and the middle latch circuit 118B.

The middle latch circuit 118B latches the pixel data Qn or the corrected pixel data Q′n output from the third adder circuit 152B.

The highest bit comparing circuit 119B compares the highest bit of the pixel data Qn read out from the input latch circuit 111B to the highest bit of the uncorrected pixel data Q′n(TEMP) generated by the second adder circuit 117B. Inconsistency of the highest bit occurs in the following cases.

Case 1: The highest bit of the pixel data Qn read out from the input latch circuit 111B is “1”, and the highest bit of the pixel data Q′n(TEMP) is “0” (for example, the case shown in FIG. 13).

Case 2: The highest bit of the pixel data Qn read out from the input latch circuit 111B is “0”, and the highest bit of the pixel data Q′n(TEMP) is “1” (for example, the case shown in FIG. 14).

The highest bit comparing circuit 119E outputs the comparison result to the correction circuit 150B. That is, if the above-mentioned highest bits are consistent, the highest bit comparing circuit 119B notifies the correction circuit 150B of consistency. If inconsistency is detected, the highest bit comparing circuit 119B notifies the correction circuit 150B of the inconsistency result of the above-mentioned case 1 or case 2.

The correction circuit 150B receives a comparison result notification from the highest bit comparing circuit 119B. The correction circuit 150B corrects the differential data Cn(TEMP) as follows.

1. In the case of consistency, the correction circuit 150B causes the differential data Cn(TEMP) to pass through as it is.

2. In the case of inconsistency of the case 1, the correction circuit 150B adds “−1” to the highest bit of the differential data Cn(TEMP).

3. In the case of inconsistency of the case 2, the correction circuit 150B adds “+1” to the highest bit of the differential data Cn(TEMP).

Next, operations of the encoder 11B in Modified Example 2 will be described.

Let's say, P is 4, M is 10, and J is 2.

The encoder circuit 110B inputs the 10-bit pixel data Qn in the encoder 11B in the order of Q1, Q2, Q3, Q4, Q5, Q6, . . . .

(Processing to First Pixel Data Q1)

First, the input latch circuit 111B latches the first pixel data Q1 input in the encoder 11B. After that, the first adder circuit 113B reads out the first pixel data Q1 at the timing when the next pixel data Q2 is input. The read out pixel data Q1 is input in the first adder circuit 113B and the compression-transform circuit 114B.

Further, the pixel data Q1 passes through the compression-transform circuit 114B. The pixel data Q1 passes through the first decompression-transform circuit 116B and the second adder circuit 117B, and is output to the highest bit comparing circuit 119B. The highest bit comparing circuit 119B compares the highest bit of the first pixel data Q1 to the highest bit of the pixel data Q1 input from the second adder circuit 117B. In this case, the highest bit comparing circuit 119B determines “consistency”. The highest bit comparing circuit 119B notifies the correction circuit 150B of the result.

The correction circuit 150E receives the “consistency” notification from the highest bit comparing circuit 119B. Then, the correction circuit 150B outputs the pixel data Q1 from the compression-transform circuit 114B to the second decompression-transform circuit 151B and the output latch circuit 115B as it is. The output latch circuit 115B latches the pixel data Q1. The output latch circuit 115B outputs the pixel data Q1 at the timing when the next data C2 is input in the output latch circuit 115B.

Meanwhile, the second decompression-transform circuit 151B inputs the pixel data Q1 input from the correction circuit 150B to the third adder circuit 152B as it is. The third adder circuit 152B outputs the pixel data Q1 to the complement circuit 112B and the middle latch circuit 118B as it is.

(Processing to Second Pixel Data Q2)

The input latch circuit 111B latches the second pixel data Q2 input in the encoder 113. After that, the first adder circuit 113B reads out the second pixel data Q2 at the timing when the next pixel data Q3 is input. The first adder circuit 113B adds the input second pixel data Q2 to the bit sequence −Q1 generated by the complement circuit 112B to thereby generate 10-bit differential data D2. The first adder circuit 113B outputs the 10-bit differential data D2 to the compression-transform circuit 114B.

The compression-transform circuit 114B compression-transforms the differential data D2 into 8-bit differential data C2(TEMP) by using the non-linear coding compression-transform property of FIG. 7. The compression-transform circuit 114B outputs the 8-bit differential data C2(TEMP) to the correction circuit 150B and the first decompression-transform circuit 116B.

The first decompression-transform circuit 116B receives the 8-bit differential data C2(TEMP) from the compression-transform circuit 114B. Then, the first decompression-transform circuit 116B decompression-transforms the 8-bit differential data. C2(TEMP) into uncorrected M-bit differential data D′2(TEMP) by using the reverse-transform property of the coding compression-transform property of FIG. 7. The second adder circuit 117B adds the decompression-transformed uncorrected M-bit differential data D′2(TEMP) to the pixel data Q1 to thereby reconstitute the pixel data Q′2(TEMP). The second adder circuit 117B outputs the pixel data Q′2(TEMP) to the highest bit comparing circuit 119B.

The highest bit comparing circuit 119B compares the highest bit of the second pixel data Q2 to the highest bit of the pixel data Q′2(TEMP) input from the second adder circuit 117B. The highest bit comparing circuit 119B outputs the comparison result to the correction circuit 150B. The comparison result is one of “consistency”, “inconsistency of case 1”, and “inconsistency of case 2”. Based on the comparison result from the highest bit comparing circuit 119B, the correction circuit 150E processes the 8-bit differential data C2(TEMP) as follows.

First, in the case where the comparison result is “consistency”, the correction circuit 150B causes the differential data C2(TEMP) to pass through, and outputs the differential data C2(TEMP) to the second decompression-transform circuit 151B and the output latch circuit 115B. The second decompression-transform circuit 151B decompression-transforms the M-bit differential data C2(TEMP). The third adder circuit 152B adds the M-bit differential data C2(TEMP) to the preceding pixel data Q1 to thereby reconstitute the 10-bit image data Q2. The third adder circuit 152B outputs the 10-bit image data Q2 to the complement circuit 112B and the middle latch circuit 118B.

In the case where the comparison result is “inconsistency of case 1”, the correction circuit 150B adds “−1” to the highest bit of the differential data C2(TEMP). The correction circuit 150B outputs the result to the second decompression-transform circuit 151B and the output latch circuit 115B. As a result, as shown in FIG. 13, in the case where the reconstituted pixel data value exceeds the maximum value of the range because of an error and reaches a value in the vicinity of 0, the reconstituted pixel data value returns to a value in the vicinity of the maximum value.

In the case where the comparison result is “inconsistency of case 2”, the correction circuit 150B adds “+1” to the highest bit of the differential data C2(TEMP). The correction circuit 150B outputs the result to the second decompression-transform circuit 151B and the output latch circuit 115B. As a result, as shown in FIG. 14, in the case where the reconstituted pixel data value does not exceed the maximum value of the range because of an error and reaches a value in the vicinity of the maximum value, the reconstituted pixel data value returns to a value in the vicinity of 0.

The output latch circuit 115B latches the pixel data C2. The output latch circuit 115B outputs the pixel data C2 at the timing when the next data C3 is input in the output latch circuit 115B.

Meanwhile, the second decompression-transform circuit 151B decompression-transforms the 8-bit differential data C2, which is input from the correction circuit 150B, into M-bit differential data D′2 by using the reverse-transform property of the coding compression-transform property of FIG. 7. The third adder circuit 152B adds the M-bit differential data D′2 to the preceding pixel data Q1 to thereby reconstitute the 10-bit pixel data Q′2. The third adder circuit 152B outputs the 10-bit pixel data Q′2 to the complement circuit 112B and the middle latch circuit 118E.

(Processing to Third Pixel Data Q3)

The input latch circuit 111B latches the third pixel data Q3 input in the encoder 11B. After that, the input latch circuit 111B outputs the third pixel data Q3 to the highest bit comparing circuit 119B and the first adder circuit 113B at the timing when the next pixel data Q4 is input. The first adder circuit 113B adds the input third pixel data Q3 to a bit sequence −Q2′, which is generated by the complement circuit 112B based on the second pixel data Q′2, to thereby generate 10-bit differential data D3. The first adder circuit 113B outputs the 10-bit differential data D3 to the compression-transform circuit 114B. The compression-transform circuit 114B compression-transforms the 10-bit differential data D3 into 8-bit differential data C3(TEMP) by using the non-linear coding compression-transform property of FIG. 7. The compression-transform circuit 114B outputs the 8-bit differential data C3(TEMP) to the correction circuit 150B and the first decompression-transform circuit 116B.

The first decompression-transform circuit 116B decompression-transforms the 8-bit differential data C3(TEMP) into M-bit differential data D′3(TEMP) by using the reverse-transform property of the coding compression-transform property of FIG. 7. The second adder circuit 117B adds the decompression-transformed M-bit differential data D′3(TEMP) to the second pixel data Q′2 to thereby reconstitute the pixel data Q′3. The second adder circuit 117B outputs the pixel data Q′3 to the highest bit comparing circuit 119B.

The highest bit comparing circuit 119B compares the highest bit of the third pixel data Q3 to the highest bit of the pixel data Q′3 input from the second adder circuit 117B. The highest bit comparing circuit 119B outputs the comparison result to the correction circuit 150B. The comparison result is one of “consistency”, “inconsistency of case 1”, and “inconsistency of case 2”. Based on the comparison result from the highest bit comparing circuit 119E, the correction circuit 150E processes the 8-bit differential data C3(TEMP) similar to the case of the second pixel data Q2.

That is, in the case where the comparison result is “consistency”, the correction circuit 150E causes the differential data C3(TEMP) to pass through, and outputs the differential data C3(TEMP) to the second decompression-transform circuit 151B and the output latch circuit 115B. The second decompression-transform circuit 151B decompression-transforms the M-bit differential data C3(TEMP). The third adder circuit 152B adds the M-bit differential data C3(TEMP) to the preceding pixel data Q′2 to thereby reconstitute the 10-bit image data Q3. The third adder circuit 152B outputs the 10-bit image data Q3 to the complement circuit 112E and the middle latch circuit 118B.

In the case where the comparison result is “inconsistency of case 1”, the correction circuit 150B adds “−1” to the highest bit of the differential data C3(TEMP). The correction circuit 150B outputs the result to the second decompression-transform circuit 1518 and the output latch circuit 115B.

In the case where the comparison result is “inconsistency of case 2”, the correction circuit 150E adds “+1” to the highest bit of the differential data C3(TEMP). The correction circuit 150B outputs the result to the second decompression-transform circuit 151B and the output latch circuit 115B.

As described above, according to Modified Example 2, it is possible to prevent the transmitted pixel data value departing from the normal value greatly because of the fact that 0 and the maximum value as differential data values are adjacent values and because of compression-transform errors of differential data.

Note that the present disclosure may employ the following configurations.

(1) A video sending apparatus, comprising:

a compression unit configured
to handle, in encoded video data encoded by pixel unit, a predetermined number of continuous pieces of pixel data as a differential-data-generating unit, the predetermined number being two or more,
to cause the first piece of pixel data in the differential-data-generating unit to pass through, and
to transform the pieces of pixel data other than the first piece of pixel data into pieces of differential data to thereby generate compressed video data, each of the pieces of differential data indicating a change amount from the preceding piece of pixel data in one of a positive direction and a negative direction; and

a sending unit configured to send the compressed video data generated by the compression unit.

(2) The video sending apparatus according to (1), wherein

the compression unit is configured to compress the transformed differential data by using a non-linear compression-transform property.

(3) The video sending apparatus according to (2), wherein

the compression unit is configured to compress the differential data by using a non-linear compression-transform property, in which the closer to the end of the range of the differential data, the higher the allocated resolution.

(4) The video sending apparatus according to any one of (1) to (3), wherein

the sending unit is configured
to divide the compressed video data into a plurality of channels, and
to send the divided compressed video data simultaneously.
   (5). The video sending apparatus according to any one of (1) to (4), wherein

the compression unit is configured
to reconstitute pieces of pixel data based on the pieces of differential data, and
to transform the pieces of pixel data other than the first piece of pixel data in the differential-data-generating unit into pieces of differential data, each of the pieces of differential data indicating a change amount from the reconstituted preceding piece of pixel data in one of a positive direction and a negative direction.
   (6) The video sending apparatus according to any one of (1) to (4), wherein

the compression unit is configured
to reconstitute pixel data based on the differential data,
to detect a change of the highest bit of the reconstituted pixel data from an original pixel data, and
to correct the compressed differential data based on the detection result.
   (7) A video receiving apparatus, comprising:

a receiving unit configured
to receive video data for transmission from a video sending apparatus according to any one of (1) to (6), and
to reverse-transform the video data for transmission into the compressed video data; and

a decompression unit configured
to cause, in the compressed video data, the first piece of pixel data in the differential-data-generating unit to pass through,
to decompress the pieces of differential data, and
to add a preceding piece of pixel data to each of the pieces of decompressed differential data to thereby reconstitute the pieces of pixel data other than the first piece of pixel data to thereby reconstitute the encoded video data.

The present disclosure contains subject matter related to that disclosed in Japanese Priority Patent Application JP 2011-133958 filed in the Japan Patent Office on Jun. 16, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video sending apparatus, comprising:
a compression unit configured
to handle, in encoded video data encoded by pixel unit, a predetermined number of continuous pieces of pixel data as a differential-data-generating unit, the predetermined number being two or more,
to cause the first piece of pixel data in the differential-data-generating unit to pass through, and
to transform the pieces of pixel data other than the first piece of pixel data into pieces of differential data to thereby generate compressed video data, each of the pieces of differential data indicating a change amount from the preceding piece of pixel data in one of a positive direction and a negative direction; and
a sending unit configured to send the compressed video data generated by the compression unit.

2. The video sending apparatus according to claim 1, wherein
the compression unit is configured to compress the transformed differential data by using a non-linear compression-transform property.

3. The video sending apparatus according to claim 1, wherein
the compression unit is configured to compress the differential data by using a non-linear compression-transform property, in which the closer to the end of the range of the differential data, the higher the allocated resolution.

4. The video sending apparatus according to claim 1, wherein
the sending unit is configured
to divide the compressed video data into a plurality of channels, and
to send the divided compressed video data simultaneously.

5. The video sending apparatus according to claim 1, wherein
the compression unit is configured
to reconstitute pieces of pixel data based on the pieces of differential data, and
to transform the pieces of pixel data other than the first piece of pixel data in the differential-data-generating unit into pieces of differential data, each of the pieces of differential data indicating a change amount from the reconstituted preceding piece of pixel data in one of a positive direction and a negative direction.

6. The video sending apparatus according to claim 1, wherein
the compression unit is configured
to reconstitute pixel data based on the differential data,
to detect a change of the highest bit of the reconstituted pixel data from an original pixel data, and
to correct the compressed differential data based on the detection result.

7. A video receiving apparatus, comprising:
a receiving unit configured
to receive video data for transmission from a video sending apparatus, the video sending apparatus being configured
to handle, in encoded video data encoded by pixel unit, a predetermined number of continuous pieces of pixel data as a differential-data-generating unit, the predetermined number being two or more,
to cause the first piece of pixel data in the differential-data-generating unit to pass through,
to transform the pieces of pixel data other than the first piece of pixel data into pieces of differential data to thereby generate compressed video data, each of the pieces of differential data indicating a change amount from the preceding piece of pixel data in one of a positive direction and a negative direction, and
to send the compressed video data, and
to reverse-transform the video data for transmission into the compressed video data; and
a decompression unit configured
to cause, in the compressed video data, the first piece of pixel data in the differential-data-generating unit to pass through,
to decompress the pieces of differential data, and
to add a preceding piece of pixel data to each of the pieces of decompressed differential data to thereby reconstitute the pieces of pixel data other than the first piece of pixel data to thereby reconstitute the encoded video data.

8. A video sending method, comprising:
handling, in encoded video data encoded by pixel unit, a predetermined number of continuous pieces of pixel data as a differential-data-generating unit, the predetermined number being two or more;
causing the first piece of pixel data in the differential-data-generating unit to pass through;
transforming the pieces of pixel data other than the first piece of pixel data into pieces of differential data to thereby generate compressed video data, each of the pieces of differential data indicating a change amount from the preceding piece of pixel data in one of a positive direction and a negative direction; and
sending the compressed video data.
